(19) United States
(12) Patent Application Publication
(10) Pub. No.: US 2026/0046969 A1
(43) Pub. Date: Feb. 12, 2026

(54) DISTRIBUTED RADIO RESOURCE CONTROL

(71) Applicant: NOKIA SOLUTIONS AND NETWORKS OY, Espoo (FI)

(72) Inventors: Janne Veikko KAASALAINEN, Soderkulla (FI); Tero HENTTONEN, Espoo (FI)

(73) Assignee: NOKIA SOLUTIONS AND NETWORKS OY, Espoo (FI)

(21) Appl. No.: 19/103,699

(22) PCT Filed: Jul. 27, 2023
(86) PCT No.: PCT/EP2023/070902

§ 371 Date: Feb. 13, 2025

(30) Foreign Application Priority Data
Aug. 18, 2022 (FI) 20225733

(51) Int. Cl. H04W 76/20; H04W 8/22; H04W 12/08

(52) U.S. Cl. CPC H04W 76/20; H04W 8/22; H04W 12/08

(57) ABSTRACT

Various example embodiments relate to radio resource control in a communication network. A method may comprise: receiving, by a distributed unit of an access node, a radio resource control identity of a device and an access stratum context associated with the radio resource control identity from a central unit of the access node: configuring, based on the access stratum context, a radio resource control entity of the distributed unit of the access node for delivery of radio resource control data to the device over a signaling radio bearer: generating radio resource control data for the device; and transmitting the radio resource control data to the device on the signaling radio bearer.

### TECHNICAL FIELD

Various example embodiments generally relate to the field of communication networks. Some example embodiments relate to distribution of radio resource control functionality between central and distributed unit(s) of an access node.

### BACKGROUND

Wireless communication networks may be operated using split access node architecture, where functionality of an access node, such as for example a 5th generation (5G) access node (gNB) is split between a central unit (CU) and one or more distributed units (DU). For example, a CU may be responsible for upper layers of a protocol stack, such as for example service data adaption protocol (SDAP), packet data convergence protocol (PDCP) and radio resource control (RRC). A distributed unit may be responsible for lower layers of the protocol stack, such as for example radio link control (RLC), medium access control (MAC), and physical layer. The split access node architecture enables disaggregation of the radio access network (RAN). Functionality of the split access node architecture may be however further improved.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure improve efficiency and quality of radio resource control. This and other benefits may be achieved by the features of the independent claims. Further example embodiments are provided in the dependent claims, the description, and the drawings.

According to a first aspect, a method is disclosed. The method may comprise: receiving, by a distributed unit of an access node, a radio resource control identity of a device and an access stratum context associated with the radio resource control identity from a central unit of the access node; configuring, based on the access stratum context, a radio resource control entity of the distributed unit of the access node for delivery of radio resource control data to the device over a signaling radio bearer; generating radio resource control data for the device; and transmitting the radio resource control data to the device on the signaling radio bearer.

According to an example embodiment of the first aspect, the radio resource control identity is independent of a serving cell of the device.

According to an example embodiment of the first aspect, the method may comprise: transmitting the radio resource control identity to the device.

According to an example embodiment of the first aspect, the method may comprise: adding the signaling radio bearer to a dedicated radio bearer configuration; transmitting an indication of the signaling radio bearer to the central unit of the access node; and receiving, from the central unit of the access node, a configuration of the signaling radio bearer.

According to an example embodiment of the first aspect, the method may comprise: receiving, from the central unit of the access node, a configuration of the dedicated radio bearer.

According to an example embodiment of the first aspect, the method may comprise: transmitting the configuration of the signaling radio bearer or the configuration of the dedicated radio bearer to the device.

According to an example embodiment of the first aspect, the configuration of the signaling radio bearer or the configuration of the dedicated radio bearer is received from the central unit of the access node in a first radio resource control reconfiguration message, or the configuration of the signaling radio bearer or the configuration of the dedicated radio bearer is transmitted to the device a second radio resource control reconfiguration message.

According to an example embodiment of the first aspect, the method may comprise: receiving, from the device, an indication of unavailability of the radio resource control identity at the device; and forwarding the indication of unavailability of the radio resource control identity at the device to the central unit of the access node.

According to an example embodiment of the first aspect, the method may comprise: receiving, from the device, a first radio resource control reconnect message comprising the radio resource control identity; and forwarding the radio resource control identity to the central unit of the access node, in response to determining that user equipment context of the device is not known to the distributed unit of the access node.

According to an example embodiment of the first aspect, the method may comprise: receiving, from the device, a first radio resource control reconnect message comprising the radio resource control identity; and selecting, based on the radio resource control identity, the access stratum context for configuration of the signaling radio bearer, in response to determining that user context of the device is known to the distributed unit of the access node.

According to an example embodiment of the first aspect, the method may comprise: reactivating, for the delivery of the radio resource control data to the device, at least one security function based on access stratum context.

According to an example embodiment of the first aspect, the method may comprise: transmitting an indication of available capacity at the distributed unit of the access node to the central unit of the access node; and receiving an indication of a capability share of the device from the central unit of the access node.

According to an example embodiment of the first aspect, the indication of unavailability of the radio resource control identity at the device is received in a first radio resource control setup request, the indication of unavailability of the radio resource control identity at the device is forwarded to the central unit of the access node in a second radio resource control setup request, the radio resource control identity is forwarded to the central unit of the access node in the second radio resource control reconnect message, or the indication of available capacity at the distributed unit of the access node is transmitted to the central unit of the access node in a radio resource control setup complete message or the second radio resource control reconnect message.

According to an example embodiment of the first aspect, at least one of the following is received from the central unit of the access node in a user equipment context setup message or a third radio resource control reconnect message: the radio resource control identity, the access stratum context, the configuration of the dedicated radio bearer, or the indication of the capability share of the device.

According to an example embodiment of the first aspect, at least one of the following is transmitted to the device in a fourth radio resource control reconnect message: the configuration of the signaling radio bearer or the configuration of the dedicated radio bearer.

According to a second aspect, a method is disclosed. The method may comprise: determining, by a central unit of an access node, an access stratum context for a device; determining a radio resource context identity for the device, wherein the radio resource context identity is associated with the access stratum context; and transmitting the radio resource control identity of the device and the access stratum context to a distributed unit of the access node.

According to an example embodiment of the second aspect, the radio resource control identity is independent of a serving cell of the device.

According to an example embodiment of the second aspect, the access stratum context and the radio resource control identity are determined in response to receiving, from the distributed unit of the access node, an indication of unavailability of the radio resource control identity at the device.

According to an example embodiment of the second aspect, the method may comprise: receiving, from the distributed unit of the access node, an indication of a signaling radio bearer added by the distributed unit of the access node to a dedicated radio bearer for delivery of radio resource control data to the device; determining a configuration for the signalling radio bearer; and transmitting the configuration of the signaling radio bearer to the distributed unit of the access node.

According to an example embodiment of the second aspect, the method may comprise: transmitting a configuration of the dedicated radio bearer to the distributed unit of the access node.

According to an example embodiment of the second aspect, the configuration of the signaling radio bearer or the configuration of the dedicated radio bearer is transmitted to the distributed unit of the access node in a radio resource control reconfiguration message.

According to an example embodiment of the second aspect, the method may comprise: reactivating, for the delivery of the radio resource control data to the device, at least one security function based on access stratum context.

According to an example embodiment of the second aspect, the method may comprise: receiving, from the distributed unit of the access node, an indication of available capacity of the distributed unit of the access node; allocating a capability share of the device to the distributed unit of the access node; and transmitting an indication of the capability share of the device to the distributed unit of the access node.

According to an example embodiment of the second aspect, the indication of unavailability of the radio resource control identity at the device is received in a radio resource control setup request, the radio resource control identity is received in a radio resource control reconnect message, or the indication of available capacity of the distributed unit of the access node is received in a radio resource control setup complete message or the radio resource control reconnect message.

According to an example embodiment of the second aspect, at least one of the following is transmitted to the distributed unit of the access node in a user equipment context setup message or another radio resource control reconnect message: the radio resource control identity, the access stratum context, the configuration of the dedicated radio bearer, or the indication of the capability share of the device.

According to an example embodiment of the second aspect, the method May comprise: receiving, from the distributed unit of the access node, an indication of radio resource control reconnection of the device; determining validity of the radio resource control identity of the device; determining an updated radio resource control identity for the device, in response to determining that the radio resource control identity is not valid; and transmitting the updated radio resource control identity to the distributed unit of the access node.

According to a third aspect, a method is disclosed. The method may comprise: receiving, from a distributed unit of an access node, an indication of a radio resource control identity for the apparatus; receiving, from the distributed unit of an access node, a configuration of a signaling radio bearer for delivery of radio resource control data, wherein the configuration of the signaling radio bearer is associated with the radio resource control identity; and receiving the radio resource control data on the signaling radio bearer.

According to an example embodiment of the third aspect, the radio resource control identity is independent of a serving cell of the apparatus.

According to an example embodiment of the third aspect, the method May comprise: transmitting an indication of unavailability of the radio resource control identity to the distributed unit of the access node.

According to an example embodiment of the third aspect, the indication of unavailability of the radio resource control identity is transmitted in a radio resource control setup request.

According to an example embodiment of the third aspect, the method may comprise: transmitting, to the distributed unit of the access node, a radio resource control reconnect message comprising the radio resource control identity.

According to an example embodiment of the third aspect, the method may comprise: receiving, from the distributed unit of the access node, a configuration of a dedicated radio bearer.

According to an example embodiment of the third aspect, the configuration of the signaling radio bearer or the configuration of the dedicated radio bearer is received from the distributed unit of the access node in a radio resource control reconfiguration message or another radio resource control reconnect message.

According to a fourth aspect, an apparatus is disclosed. The apparatus may comprise means for performing a method according to the first, second, or third aspect, or any example embodiment thereof.

According to a fifth aspect, a computer program or a computer program product is disclosed. The computer program or computer program product may comprise instructions, which when executed by an apparatus, cause the apparatus perform the method according to the first, second, or third aspect, or any example embodiment thereof.

According to a sixth aspect, an apparatus is disclosed. The apparatus may comprise at least one processor; and at least one memory storing instructions that, when executed by the at least one processor, cause the apparatus at least to: receive, by a distributed unit of an access node, a radio resource control identity of a device and an access stratum context associated with the radio resource control identity from a central unit of the access node; configure, based on the access stratum context, a radio resource control entity of the distributed unit of the access node for delivery of radio resource control data to the device over a signaling radio bearer; generate radio resource control data for the device; and transmit the radio resource control data to the device on the signaling radio bearer.

According to an example embodiment of the sixth aspect, the radio resource control identity is independent of a serving cell of the device.

According to an example embodiment of the sixth aspect, the instructions, when executed by the at least one processor, cause the apparatus to: transmit the radio resource control identity to the device.

According to an example embodiment of the sixth aspect, the instructions, when executed by the at least one processor, cause the apparatus to: add the signaling radio bearer to a dedicated radio bearer configuration; transmit an indication of the signaling radio bearer to the central unit of the access node; and receive, from the central unit of the access node, a configuration of the signaling radio bearer.

According to an example embodiment of the sixth aspect, the instructions, when executed by the at least one processor, cause the apparatus to: receive, from the central unit of the access node, a configuration of the dedicated radio bearer.

According to an example embodiment of the sixth aspect, the instructions, when executed by the at least one processor, cause the apparatus to: transmit the configuration of the signaling radio bearer or the configuration of the dedicated radio bearer to the device.

According to an example embodiment of the sixth aspect, the configuration of the signaling radio bearer or the configuration of the dedicated radio bearer is received from the central unit of the access node in a first radio resource control reconfiguration message, or the configuration of the signaling radio bearer or the configuration of the dedicated radio bearer is transmitted to the device a second radio resource control reconfiguration message.

According to an example embodiment of the sixth aspect, the instructions, when executed by the at least one processor, cause the apparatus to: receive, from the device, an indication of unavailability of the radio resource control identity at the device; and forward the indication of unavailability of the radio resource control identity at the device to the central unit of the access node.

According to an example embodiment of the sixth aspect, the instructions, when executed by the at least one processor, cause the apparatus to: receive, from the device, a first radio resource control reconnect message comprising the radio resource control identity; and forward the radio resource control identity to the central unit of the access node, in response to determining that user equipment context of the device is not known to the distributed unit of the access node.

According to an example embodiment of the sixth aspect, the instructions, when executed by the at least one processor, cause the apparatus to: receive, from the device, a first radio resource control reconnect message comprising the radio resource control identity; and select, based on the radio resource control identity, the access stratum context for configuration of the signaling radio bearer, in response to determining that user context of the device is known to the distributed unit of the access node.

According to an example embodiment of the sixth aspect, the instructions, when executed by the at least one processor, cause the apparatus to: reactivate, for the delivery of the radio resource control data to the device, at least one security function based on access stratum context.

According to an example embodiment of the sixth aspect, the instructions, when executed by the at least one processor, cause the apparatus to: transmit an indication of available capacity at the distributed unit of the access node to the central unit of the access node; and receive an indication of a capability share of the device from the central unit of the access node.

According to an example embodiment of the sixth aspect, the indication of unavailability of the radio resource control identity at the device is received in a first radio resource control setup request, the indication of unavailability of the radio resource control identity at the device is forwarded to the central unit of the access node in a second radio resource control setup request, the radio resource control identity is forwarded to the central unit of the access node in the second radio resource control reconnect message, or the indication of available capacity at the distributed unit of the access node is transmitted to the central unit of the access node in a radio resource control setup complete message or the second radio resource control reconnect message.

According to an example embodiment of the sixth aspect, at least one of the following is received from the central unit of the access node in a user equipment context setup message or a third radio resource control reconnect message: the radio resource control identity, the access stratum context, the configuration of the dedicated radio bearer, or the indication of the capability share of the device.

According to an example embodiment of the sixth aspect, at least one of the following is transmitted to the device in a fourth radio resource control reconnect message: the configuration of the signaling radio bearer or the configuration of the dedicated radio bearer.

According to a seventh aspect, an apparatus is disclosed. The apparatus may comprise at least one processor; and at least one memory storing instructions that, when executed by the at least one processor, cause the apparatus at least to: determine, by a central unit of an access node, an access stratum context for a device; determine a radio resource context identity for the device, wherein the radio resource context identity is associated with the access stratum context; and transmit the radio resource control identity of the device and the access stratum context to a distributed unit of the access node.

According to an example embodiment of the seventh aspect, the radio resource control identity is independent of a serving cell of the device.

According to an example embodiment of the seventh aspect, the access stratum context and the radio resource control identity are determined in response to receiving, from the distributed unit of the access node, an indication of unavailability of the radio resource control identity at the device.

According to an example embodiment of the seventh aspect, the instructions, when executed by the at least one processor, cause the apparatus to: receive, from the distributed unit of the access node, an indication of a signaling radio bearer added by the distributed unit of the access node to a dedicated radio bearer for delivery of radio resource control data to the device; determine a configuration for the signalling radio bearer; and transmit the configuration of the signaling radio bearer to the distributed unit of the access node.

According to an example embodiment of the seventh aspect, the instructions, when executed by the at least one processor, cause the apparatus to: transmit a configuration of the dedicated radio bearer to the distributed unit of the access node.

According to an example embodiment of the seventh aspect, the configuration of the signaling radio bearer or the configuration of the dedicated radio bearer is transmitted to the distributed unit of the access node in a radio resource control reconfiguration message.

According to an example embodiment of the seventh aspect, the instructions, when executed by the at least one processor, cause the apparatus to: reactivate, for the delivery of the radio resource control data to the device, at least one security function based on access stratum context.

According to an example embodiment of the seventh aspect, the instructions, when executed by the at least one processor, cause the apparatus to: receive, from the distributed unit of the access node, an indication of available capacity of the distributed unit of the access node; allocate a capability share of the device to the distributed unit of the access node; and transmit an indication of the capability share of the device to the distributed unit of the access node.

According to an example embodiment of the seventh aspect, the indication of unavailability of the radio resource control identity at the device is received in a radio resource control setup request, the radio resource control identity is received in a radio resource control reconnect message, or the indication of available capacity of the distributed unit of the access node is received in a radio resource control setup complete message or the radio resource control reconnect message.

According to an example embodiment of the seventh aspect, at least one of the following is transmitted to the distributed unit of the access node in a user equipment context setup message or another radio resource control reconnect message: the radio resource control identity, the access stratum context, the configuration of the dedicated radio bearer, or the indication of the capability share of the device.

According to an example embodiment of the seventh aspect, the instructions, when executed by the at least one processor, cause the apparatus to: receive, from the distributed unit of the access node, an indication of radio resource control reconnection of the device; determine validity of the radio resource control identity of the device; determine an updated radio resource control identity for the device, in response to determining that the radio resource control identity is not valid; and transmit the updated radio resource control identity to the distributed unit of the access node.

According to an eighth aspect, an apparatus is disclosed. The apparatus may comprise at least one processor; and at least one memory storing instructions that, when executed by the at least one processor, cause the apparatus at least to: receive, from a distributed unit of an access node, an indication of a radio resource control identity for the apparatus; receive, from the distributed unit of an access node, a configuration of a signaling radio bearer for delivery of radio resource control data, wherein the configuration of the signaling radio bearer is associated with the radio resource control identity; and receive the radio resource control data on the signaling radio bearer.

According to an example embodiment of the eighth aspect, the radio resource control identity is independent of a serving cell of the apparatus.

According to an example embodiment of the eighth aspect, the instructions, when executed by the at least one processor, cause the apparatus to: transmit an indication of unavailability of the radio resource control identity to the distributed unit of the access node.

According to an example embodiment of the eighth aspect, the indication of unavailability of the radio resource control identity is transmitted in a radio resource control setup request.

According to an example embodiment of the eighth aspect, the instructions, when executed by the at least one processor, cause the apparatus to: transmit, to the distributed unit of the access node, a radio resource control reconnect message comprising the radio resource control identity.

According to an example embodiment of the eighth aspect, the instructions, when executed by the at least one processor, cause the apparatus to: receive, from the distributed unit of the access node, a configuration of a dedicated radio bearer.

According to an example embodiment of the eighth aspect, the configuration of the signaling radio bearer or the configuration of the dedicated radio bearer is received from the distributed unit of the access node in a radio resource control reconfiguration message or another radio resource control reconnect message.

According to a ninth aspect, a (non-transitory) computer readable medium is disclosed. The (non-transitory) computer readable medium may comprise program instructions that, when executed by an apparatus, cause the apparatus to perform a method according to the first, second, or third aspect, or any example embodiment thereof.

Example embodiments of the present disclosure can thus provide apparatuses, methods, computer programs, computer program products, or computer readable media for improving radio resource control in case of a distributed network architecture Any example embodiment may be combined with one or more other example embodiments. These and other aspects of the present disclosure will be apparent from the example embodiment(s) described below. According to some aspects, there is provided the subject matter of the independent claims. Some further aspects are defined in the dependent claims.

### DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of a split access node architecture;

FIG. 2 illustrates an example of implementation of various protocols in a split access node architecture;

FIG. 3 illustrates an example of an apparatus configured to practice one or more example embodiments;

FIG. 4 illustrates an example of implementation of various protocols in a split access node architecture with split RRC functionality;

FIG. 5 illustrates an example of a message sequence and operations for initial setup when gNB does not have UE context;

FIG. 6 illustrates an example of a message sequence and operations for RRC reconnection setup when gNB-DU has UE context;

FIG. 7 illustrates an example of a message sequence and operations for RRC reconnection setup when gNB-DU does not have UE context;

FIG. 8 illustrates an example of a message sequence and operations for different RRC reconnection options;

FIG. 9 illustrates an example of a method for radio resource control at a distributed unit of an access node;

FIG. 10 illustrates example of a method for radio resource control at a central unit of an access node; and

FIG. 11 illustrates an example of a method for radio resource control at a device.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

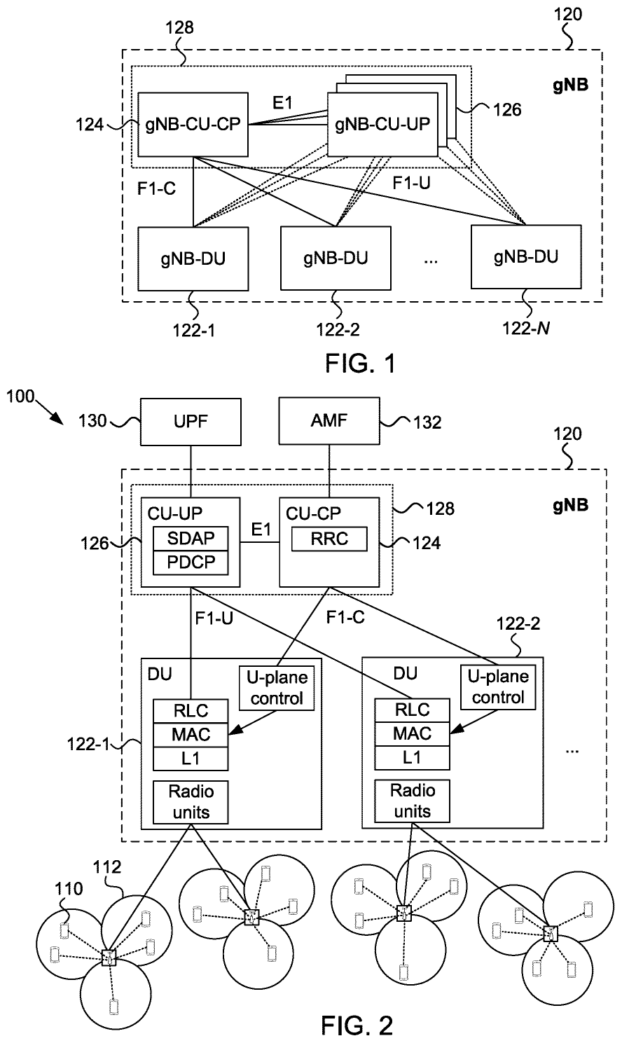

FIG. 1 illustrates an example of a split access node architecture. An access node, represented by gNB 120, may be split, functionally and/or physically, to a central unit (CU) 128 and one or more distributed units (DU) 122-1, 122-2, . . . , 122-N. CU 128 may be also referred to as gNB-CU and DU(s) be also referred to as gNB-DU(s). CU 128 may comprise a control plane (CP) and user plane (UP) entities, represented by gNB-CU-CP 124 and gNB-CU-UP 126, respectively. The gNB-CU-CP 124 may be configured to control communication of signaling data that enables transfer of user/application data at the user plane. User plane communications may be provided by one or more gNB-CU-UPs 126 associated with gNB-CU-CP 124. CU 128 and DU(s) may be configured to provide radio access network (RAN) services to device(s), represented by user equipment (UE) 110, at one or more cells 112.

Control and user plane entities of CU 128 may communicate via a communication interface, such as for example an E1 interface. CU 128 may communicate with a DU 122-n (n=1 . . . N) over a communication interface, such as for example an F1 interface. The F1 interface may comprise control and user plane interfaces (F1-C, F1-U) between DU 122-n and the control and user plane entities of CUs 128, respectively. DU(s) 122-1 to 122-N may be collectively referred to as DU(s) 122, where N is a positive integer ranging for example from 1 to 100. However, higher values, such as for example up to 236-1, are possible as well.

The CU/DU-split architecture enables disaggregation of the RAN, thus enabling operators to utilize different vendors for different network nodes, but also to enable network vendors to split their network implementations for scalability purposes. For example, control and user planes may be separated to their own entities, thereby enabling control and user plane functions to be dimensioned separately. The split may be however (almost) invisible to a user equipment (UE) and therefore, at the UE side, the protocol layers may be (mostly) unaware of the split, except for minor parts which the UE may implicitly determine from the associated RRC configuration.

FIG. 2 illustrates an example of protocol layers in a communication network using a split access node architecture. UE 110 may access application services via radio access network (RAN) comprising one or more gNBs 120. UE 110 may communicate with gNB 120 over a radio interface, configured for example based on the 5G NR (New Radio) standard defined by the 3rd Generation Partnership Project (3GPP). Communication network 100 may therefore comprise a wireless communication network.

A core network of the communication network may be implemented with various network functions, including for example user plane function (UPF) 130 and access and mobility management function (AMF) 132. UPF 130 may be configured to handle user data part of a communication session. UPF 130 may thus provide an interconnect point between the radio access network and a data network. For example, UPF 130 may be configured to handle encapsulation and decapsulation of user plane protocol(s), such as for example the GPRS (general packet radio service) tunnelling protocol for the user plane (GTP-U). UPF 130 may be therefore configured to communicate with CU-UP 126. AMF 132 may be configured to receive connection and session request related data from UE 110 (via a gNB). AMF 132 may be configured to control connection and mobility management in the wireless communication network. AMF 132 may be therefore configured to communicate with CU-CP 124.

Communication network 100 may be operated based on a protocol stack comprising a plurality of protocol layers. The protocol stack may be arranged based on the open systems interconnection (OSI) model or a layer model of a particular standard. In one example, the protocol stack may comprise a service data adaptation protocol (SDAP) layer, which may receive data from an application layer for transmission. The SDAP layer may be configured to exchange data with the packet data convergence (PDCP) layer. The PDCP layer may be responsible of generation of data bursts comprising one or more data packets, for example based on data obtained from the SDAP layer.

The PDCP layer may provide data to one or more instances of the radio link control (RLC) layer. For example, PDCP data may be transmitted on one or more RLC transmission legs. Each RLC instance may be associated with corresponding MAC instances of the MAC layer. The MAC layer may provide a mapping between logical channels of upper layer(s) and transport channels of the physical layer, handle multiplexing and demultiplexing of MAC service data units (SDU). Furthermore, the MAC layer may provide error correction functionality based on packet retransmissions, for example according to the hybrid automatic repeat request (HARQ) process. Physically separate transmission legs may be provided by the physical (PHY) layer, also known as Layer 1 (L1). The RLC, MAC, and L1 functionality may reside on DU(s) 122. Corresponding protocol stacks may be applied both at gNB 120 and UE 110.

In a split access node architecture part of the protocol layers may be implemented at CU 128. In the example of FIG. 2, CU 128 (e.g., CU-UP 126) may be configured to handle upper layers of the protocol stack, for example SDAP and PDCP layers. Furthermore, CU 128 (e.g., CU-CP 124) may be configured to handle radio resource control (RRC) operations. DU(s) 122 may be configured to handle lower layers of the protocol stack, for example RLC, MAC, and L1. A user plane (U-plane) control function may interact with the MAC layer to encapsulate RRC data received from CU-CP 124 in MAC packets and/or decapsulate RRC data from MAC packets and provide the RRC data to CU-CP 124. Radio unit(s) of the DU(s) 122 may transmit/receive data to/from UE(s) over a radio interface.

When UE 110 is powered up, it may be in a disconnected state or an idle state (e.g. RRC_IDLE). UE 110 may move to a connected state (e.g. RRC_CONNECTED) for example through connection establishment to the network. If UE 110 is not active for a certain time, UE 110 may move from the connected state to an inactive state (e.g. RRC_INACTIVE).

In the idle state UE 110 may not be associated with an RRC context. From the network point of view there may not be a connection between the radio access network and the core network for UE 110. Therefore, UE 110 may not communicate application data with the network. UE 110 may be also in a sleep-mode and only intermittently wake-up, for example for receiving paging messages. UE 110 may however perform cell re-selection and other idle state operations. In the connected state, UE 110 may be associated with an RRC context. In the connected state, UE 110 may communicate with the core network via the radio access network, for example gNB 120.

In the inactive state, UE 110 may stay registered to the network, but the connection to the radio access network may be suspended. However, the radio access network may store the UE context, which enables the connection to be quickly resumed. Connection to the core network may be maintained.

In the connected state, the UE 110 may perform radio resource management (RRM) measurements, for example in relation to a mobility (handover) procedure. UE 110 may report its measurement results to the network (e.g. via gNB 120), for example periodically and/or in response to detecting a reporting triggering criterion to be fulfilled. Even though some example embodiments have been described using the RRC_IDLE, RRC_INACTIVE, or RRC_CONNECTED states of the 5G system as examples, it is appreciated the example embodiments may be applied to other type of idle, inactive, or connected states, for example having similar characteristics as the RRC_IDLE, RRC_INACTIVE, or the RRC_CONNECTED states. An RRC state may be also referred to as an RRC mode.

As noted above, one CU may include several DUs. Furthermore, one DU may serve multiple cells, for example tens of cells. Providing the RRC layer in CU 128 may enable good control of mobility of UE 110 and also enable it to operate as a central resource manager for UE 110. However, a problem in this architecture is that all RRC signaling may need to be routed trough CU 128, which does not actually define much of the content for RRC messages, for example because the most frequently changed configuration parameters may be related to L1 features controlled by the DU(s) 122.

DU(s) 122 may include a resource manager that controls lower layer radio parameter usage, e.g., periodical physical uplink control channel (PUCCH) resources, and also some central computing unit (CPU) computing resources. These may have complicated connections to radio resource usage. To make this visible via an open multivendor interface between the central and distributed units, such as for example F1-C, may be difficult. On the other hand, lack of needed information at CU 128 may lead to low gain or additional latency for RRC message handling, when responsibility of building RRC messages towards UE 100 lies solely at the CU 128. Example embodiments of the present disclosure therefore enable a split RRC architecture, where RRC connection may be identified with a CU specific RRC identity (ID), which may not be associated with a particular cell. RRC anchor point based RRC may be therefore used instead of cell specific RRC.

Communication network 100 may comprise other network function(s), network device(s), or protocol(s), in addition, or alternative to, those illustrated in FIG. 2. Even though some embodiments have been described in the context of 5G, it is appreciated that embodiments of the present disclosure are not limited to this example network. Example embodiments may be therefore applied in any present or future communication networks. An apparatus may comprise, or be configured to implement, e.g. by means of software, one or more of the protocol layers described herein.

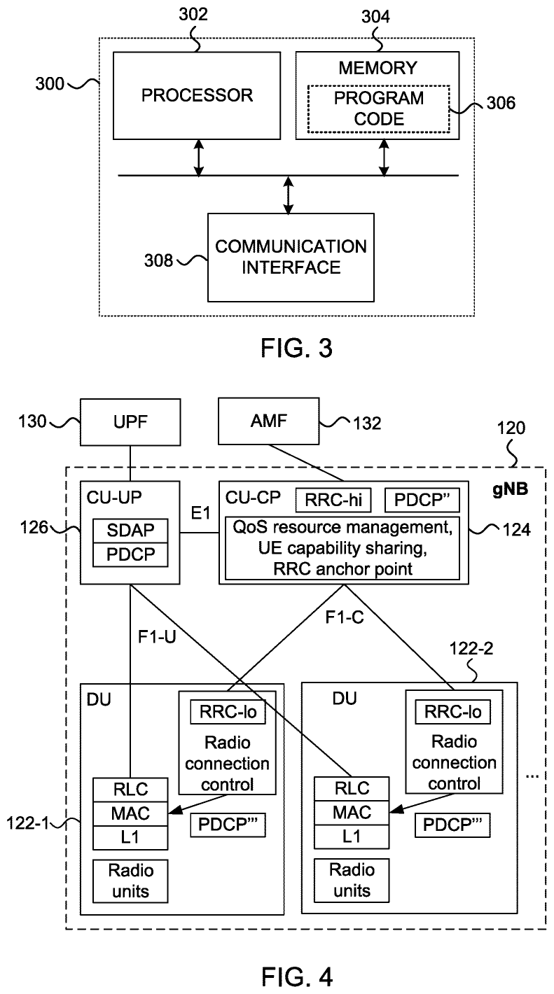

FIG. 3 illustrates an example of an apparatus configured to practice one or more example embodiments. Apparatus 300 may comprise an access node, an access point, base station, a radio network node, or a split portion thereof, or in general a device configured to implement functionality described herein. Apparatus 300 may comprise at least one processor 302. The at least one processor 302 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 300 may further comprise at least one memory 304. The memory 304 may be configured to store, for example, computer program code or the like, for example operating system software and application software. The memory 304 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.). Memory 304 is provided as an example of a (non-transitory) computer readable medium. The term “non-transitory,” as used herein, is a limitation of the medium itself (i.e., tangible, not a signal) as opposed to a limitation on data storage persistency (e.g., RAM vs. ROM).

Apparatus 300 may further comprise a communication interface 308 configured to enable apparatus 300 to transmit and/or receive information. The communication interface 308 may comprise an internal or external communication interface, such as for example an E1, F1, F1-C, and/or F2-C interface. Apparatus 300 may further comprise other components and/or functions such as for example a user interface (not shown) comprising at least one input device and/or at least one output device. The input device may take various forms such a keyboard, a touch screen, or one or more embedded control buttons. The output device may for example comprise a display, a speaker, or the like.

When apparatus 300 is configured to implement some functionality, some component and/or components of apparatus 300, such as for example the at least one processor 302 and/or the at least one memory 304, may be configured to implement this functionality. Furthermore, when the at least one processor 302 is configured to implement some functionality, this functionality may be implemented using program code 306 comprised, for example, in the at least one memory 304.

The functionality described herein may be performed, at least in part, by one or more computer program product components such as software components. According to an example embodiment, apparatus 300 comprises a processor or processor circuitry, such as for example a microcontroller, configured by the program code 306, when executed, to execute the embodiments of the operations and functionality described herein. Program code 306 is provided as an example of instructions which, when executed by the at least one processor 302, cause performance of apparatus 300.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), graphics processing units (GPUs), or the like.

Apparatus 300 may be configured to perform method(s) described herein or comprise means for performing method(s) described herein. In one example, the means comprises the at least one processor 302, the at least one memory 304 including program code 306 configured to, when executed by the at least one processor 302, cause apparatus 300 to perform the method(s).

Apparatus 300 may comprise, for example, a network device, for example, an access node, an access point, a base station, or a central/distributed unit thereof. Although apparatus 300 is illustrated as a single device, it is appreciated that, wherever applicable, functions of apparatus 300 may be distributed to a plurality of devices.

FIG. 4 illustrates an example of implementation of various protocols in a split access node architecture with split RRC functionality. Example embodiments of the present disclosure provide solutions for current and next generation networks, such as 6G networks, where radio resource control is split between central and distributed units, in other words, disaggregated according to the CU/DU split. This enables both CU 128 and DU(s) 122 to exchange RRC messages with UE 110. The RRC protocol may be therefore disconnected from cell dependency such that UE 110 may retain part of the RRC protocol even between state transitions. A radio connection may not be needed for retaining (part of) the RRC protocol. Hence, UE 110 may be in an RRC inactive type of state and ready for resuming the RRC connection without separate state transition. This provides the benefit of simplifying RRC state handling after completion of initial network registration. For example, signalling overhead caused by exchange of unnecessary information between CU 128 and DU(s) 122 may be reduced. This also enables more effective radio resource control, since DU(s) 122 may have more information on the parameters affecting certain aspects of RRC.

Furthermore, at the network side the roles of central and distributed units are clarified by splitting RRC into two parts, e.g. RRC-hi(gh), which may be anchored at CU 128 (e.g. CU-CP 124), and RRC-lo(w), which may be anchored at DU(s) 122. RRC-hi may be configured to take care of QoS flow resource management, UE capability sharing, and/or act as an RRC connection anchor point towards core network, for example AMF 132.

RRC-lo at the DU(s) 122 may be configured to take care of radio connection related configurations (e.g. physical layer configurations). RRC-lo may be configured to interact with the MAC layer, for example to include/extract RRC data (either RRC-lo or both RRC-hi/lo) to/from MAC packets. However, towards UE 110 the RRC protocol may still appear as one RRC. UE 110 may process the RRC messages as if the RRC layer were a single entity. Some PDCP functionality (PDCP′″) may be therefore included at the DU(s) 122 instead, or in addition to, PDCP layer of CU 128 (PDCP″).

The split between RRC-lo/hi may be implemented for example such that cell group configuration (CellGroupConfig) parameters of RRC reconfiguration information elements are included in RRC-lo. This enables DU(s) 122 to deliver cell group configuration parameters directly to UE 110. RRC-hi may include parameters of radio bearer configuration (RadioBearerConfig), which enables CU 128 to centrally handle radio bearer configurations. A cell group configuration may include configurations for a group of cells (e.g. two, three, or more cells), which may be identified in the cell group information by a cell group identifier (CellGroupID). The cell group configuration may include for example physical or MAC layer configurations for the group of cells.

To enable separation of RRC from CU 128, CU 128 may define, for example in an RRC setup procedure, an RRC ID that is independent from the cell identifier (cell_id) of the serving cell of UE 110. RRC ID may be used for configuring RRC transmission, for example for derivation of security keys. RRC ID may be used for this purpose in addition to, or instead of, the cell identifier (e.g. physical cell identifier, PCI) received from the serving cell. The gNB 120 may define a validity period for the RRC ID. In response to detecting expiry of the validity period, UE 110 may perform connection re-establishment, where UE 110 may indicate unavailability of (valid) RRC ID. This may be done as if starting without any stored RRC configuration.

In one example, CU 128 may share the access stratum (AS) context with DU(s) 122. This allows DU(s) 122 to establish an independent RRC entity for UE 110. Hence, RRC-lo may have a separate RRC entity for ciphering and integrity protecting the used signaling radio bearer (SRB) toward UE 110. This may be also implemented via a separate SRB for DU(s) 122 inside RRC. AS context may comprise a set of parameters that enables UE security and integrity verification.

In another example, CU 128 and DU(s) 122 may be configured to establish independent RRC message contexts. In this case, CU 128 may provide to DU(s) 122, together with the AS context, also integrity protection and security keys for RRC data. This way DU(s) 122 are enabled to add content to RRC message(s) and also to generate their own RRC messages using the same SRB used on CU 128. Consistency of integrity protection and security keys may be maintained with a key update procedure

In another example, CU 128 may provide the RRC ID to DU(s) 122 in a non-RRC message, for example an F1 message. The CU 128 may secure the RRC ID with integrity and security algorithms and provide it to DU(s) 122. The F1 message may also contain parameters from CU 128. DU(s) 122 may generate final RRC message(s), but add to the message(s) the RRC ID container received from CU 128.

With any of the above examples, UE 110 may be enabled to access the RRC connection associated with the RRC ID from any radio point that is has established with DU(s) 122, whenever UE 110 needs an RRC connection. If UE 110 has the RRC ID immediately available at the beginning of the RRC connection, the rest of the RRC connection procedures may be simplified. UE 110 may be also configured with multiple radio connections. In case some radio connection(s) are not needed, DU(s) 122 may release the radio connection(s) that it has. If all radio connections from all DU(s) 122 are released, UE 110 is in an “RRC inactive” like state without a need for any additional configurations. CU 128 may maintain the context, for example for a defined time, and be ready for fast resume of the RRC connection. The concept of RRC may be therefore enhanced such that DU(s) 122 may use any method to establish a radio connection with UE 100 as there is no cell dependency. The radio interface of DU(s) 122 may be based on transmission-reception point (TRP), cells, or cell-less concepts.

Once DU(s) 122 receives the RRC ID from UE 110, it may verify it with CU 128, receive a share of UE capability, the AS context, or an indication/configuration of a possibly already existing data connection. UE 110 may establish multiple radio connections in DU(s) 122 and CU 128 may be configured to split the data in the DU(s) 122 and also to (fully) control mobility of UE 110 within DU(s) 122. If UE 110 is capable for multiple uplinks, it may also establish radio connections with multiple DUs 122 transparently. Hence, UE 110 may operate without seeing any DU borders.

The disclosed methods enable UE 110 to always use the best configured uplink for RRC message transfer. Any DU 122-n may be configured to take care of mobility within its cells and also to apply any RRC reconfiguration that is triggered therein. As UE 110 is continuously ready for resuming the RRC connection, the disclosed methods may also clearly reduce the need for handovers. In many cases, UE 110 may immediately resume the data transfer in any radio access point in the gNB area. In handover, UE 110 may send an indication of whether it has split capability, e.g., being able to receive data from source and target cells or just from the target cell so UE make request additional resources or switch of resources. For example, UE 110 may be configured to have multiple DU RRC connections, e.g. one with source cell and one with target cell. In this case, a handover may not be needed as UE 110 may be configured with secondary (target) DU. Once the secondary DU has been configured, the source DU can be released. This target configuration may be initiated by the network, or directly by UE 110, e.g. by sending a request for new DU (cell) while continuing to receive data from the source cell (DU). As disclosed herein, an RRC ID, which may be also called an AS context ID, may defined for UE 110 and provided to UE 110 as well as for DU(s) 122. The RRC ID may include parameter(s) that replace cell based UE ID(s) (e.g. ue-Identity).

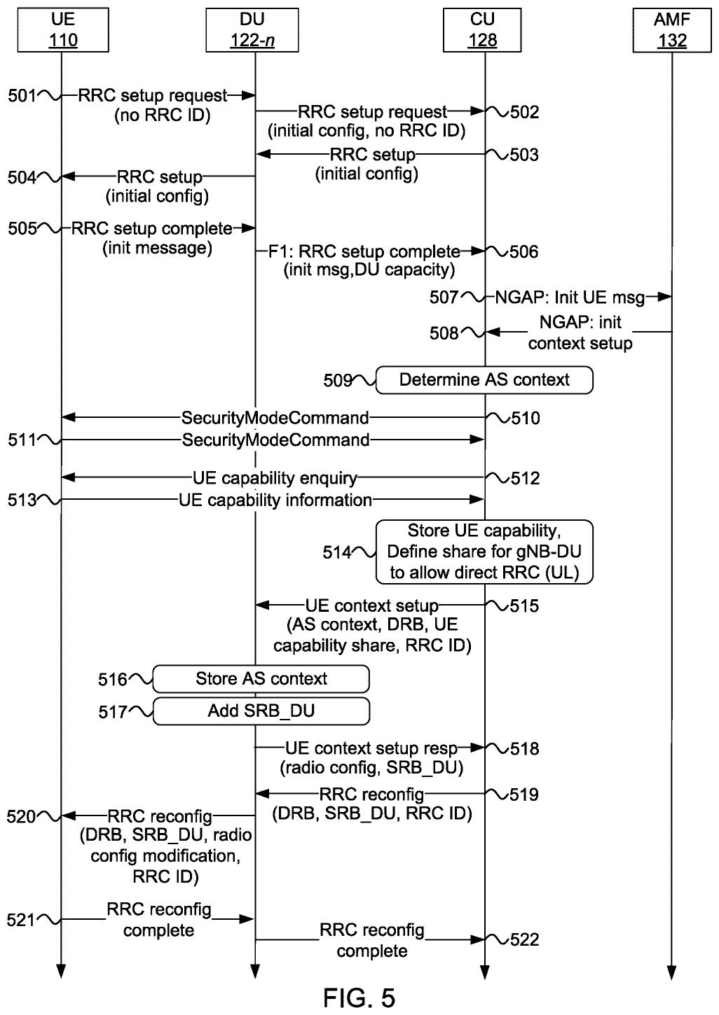

FIG. 5 illustrates an example of a message sequence and operations for initial setup when the gNB does not have UE context. Even though the figures illustrate functionality based on certain messages, it is understood that similar functionality may be implemented with different type of messages. However, using the messages described herein may be beneficial for implementing the example embodiments in context of 3GPP specifications. Even though operations have been illustrated between CU 128 and a single DU 122-n, it is appreciated that similar operations may be performed between CU 128 and multiple DU(s) 122, for example to allocate different shares of UE capability to different DUs.

At operation 501, UE 110 may transmit an RRC setup request to DU 122-n. At this point, UE 110 may not have an RRC connection to the network. UE 110 may not be associated with an RRC ID. The RRC setup request may comprise an indication of unavailability of the RRC ID at UE 110 (“no RRC ID”). The RRC setup request may for example comprise an information element (IE) indicating that UE 110 does not have RRC connection in the network. The indication of unavailability of the RRC ID may be therefore transmitted as an indication not having RRC connection to the network, which also means that UE 110 does not have an RRC ID. The indication of unavailability of the RRC ID may be provided as an RRC setup request that does not include an RRC ID.

At operation 502, DU 122-n may transmit an RRC setup request comprising the indication of unavailability of the RRC ID at UE 110 to CU 128. The indication of the unavailability may be thus forwarded to CU 128. The RRC setup request may comprise an initial configuration. For example, DU 122-n may include the received RRC setup request message and, if UE 110 is admitted, the corresponding low layer configuration for UE 110 in an INITIAL UL (uplink) RRC MESSAGE TRANSFER message and transfer this message to CU 128. The INITIAL UL RRC MESSAGE TRANSFER message may include the cell radio network temporary identifier (C-RNTI) allocated to UE 110 by DU 122-n.

At operation 503, CU 128 may transmit an RRC setup message to DU 122. For example, CU 128 may allocate a gNB-CU UE F1AP (F1 application protocol) ID for UE 110 and include it in the RRC setup message. The RRC setup message may be encapsulated in a DL (downlink) RRC MESSAGE TRANSFER message. The gNB-CU UE F1AP ID may uniquely identify UE 110 over the F1 interface within CU 128.

At operation 504, DU 122-n may send the RRC setup message to UE 110.

At operation 505, UE 110 may transmit an RRC (connection) setup complete message to DU 122-n. The RRC setup complete message may comprise an initial message, which may be a first message from UE 110 to the core network (e.g. AMF 132). Once the RRC connection has been established, UE 110 may initiate communication with AMF 132.

At operation 506, DU 122-n may transmit an RRC setup complete message to CU 128, for example over the F1 interface. The RRC setup complete message may include the initial message. The RRC setup complete message may include an indication of available capacity at DU 122-n. The available capacity may be indicated for example as percentage of available capacity, for example by information element Capacity Value that indicates, for example as an integer value between 0 and 100, the amount of resources per cell and per synchronization signaling block (SSB) area that are available relative to the total resources of DU 122-n.

At operation 507, CU 128 may transmit the initial UE message to AMF 132, for example as an NGAP (next generation application protocol) message.

At operation 508, CU 128 may transmit an initial context setup message to DU 122-n, for example as an NGAP protocol message.

At operation 509, CU 128 may determine an access stratum (AS) context for UE 110.

At operation 510, CU 128 may transmit a SecurityModeCommand to UE 110 via DU 122-n.

At operation 511, UE 110 may transmit a SecurityModeCommand to CU 128 via DU 122-n.

At operation 512, CU 128 may transmit a UE capability enquiry to UE 110 via DU 122-n.

At operation 513, UE 110 may transmit UE capability information to CU 128 via DU 122-n. The UE capability information may include an indication of whether UE 110 supports use of RRC ID.

At operation 514, CU 128 may store the UE capability information and allocate a share for DU 122-n to allow direct RRC (uplink) communication with UE 110. This means that CU 128 allows an own signaling radio bearer (SRB) for DU 122-n. CU 128 may determine the share of the UE capability that it allocates to DU 122-n based on the UE capability information and the available capacity of DU 122-n.

At operation 515, CU 128 may transmit a UE context setup message to DU 122-n. The UE context setup message may comprise at least one of the following: the AS context, a configuration of a dedicated radio bearer (DRB), the UE capability share, or the RRC ID. The RRC ID may be associated with the AS context or the DRB configuration, or both. In other words, the AS context or the DRB configuration may be applicable for a UE having the particular RRC ID. The RRC ID may be independent of the serving cell of UE 110. This enables UE 110 to use the RRC ID for subsequently resuming the RRC connection in another cell.

UE context may comprise a block of information maintained a RAN node (e.g. CU 128 or DU 122-n) associated to one UE. The block of information may include information for maintaining RAN services towards an active UE. UE context may be established when transition to RRC connected state for the respective UE is completed, or in a target RAN node after completion of handover resource allocation during handover preparation. UE context may comprise UE state information, security information, UE capability information, or identities of the UE-associated logical network connection.

At operation 516, DU 122-n may store the AS context. The AS context may be subsequently used for delivery of RRC data to UE 110. An RRC entity may be configured, for example established, at DU 122-n for this purpose. This enables DU 122-n to communicate RRC data with UE 110 directly, without routing the data to CU 128. When stored, the AS context may be associated with the RRC ID.

At operation 517, DU 122-n may add an SRB for DU 122-n (SRB_DU). The SRB may be added to the DRB configuration.

At operation 518, DU 122-n may transmit a UE context setup response to CU 128. The UE context setup response may include at least one of the following: a radio configuration or an indication of the added SRB (SRB_DU). In response to receiving the indication of the added SRB, CU 128 may determine a configuration for the SRB. The radio configuration may comprise cell group configuration.

At operation 519, CU 128 may transmit an RRC reconfiguration message to DU 122-n. The RRC reconfiguration message may include at least one of the following: a configuration of the dedicated radio bearer, a configuration of the signaling radio bearer (SRB_DU), or the RRC ID. Providing RRC ID at UE context setup of operation 515 enables to configure DU 122-n. Providing the RRC ID at RRC reconfiguration message of operation 519 enables configuration of UE 110 via DU 122-n. The content of RRC reconfiguration may be transparent (not readable) for DU 122-n. In this case, SRB_DU configuration may include parameters for opening subsequent SRB_DU messages. Similarly, providing the RRC ID in UE context setup of operation 515 enables configuration of DU 122-n, since the content of RRC reconfiguration of operation 519 may be transparent to DU 122-n.

At operation 520, DU 122-n may transmit an RRC reconfiguration message to UE 110. This RRC reconfiguration message may include at least one of the following: the configuration of the dedicated radio bearer, SRB_DU, radio config modification, or the RRC ID. UE 110 may store the received information. Radio configuration may comprise the cell group configuration, for example frequency configuration, information about reference signal, or the like. SRB configuration (e.g. SRB_DU) may include parameters for reading and using SRB data.

At operation 521, UE 110 may transmit an RRC reconfiguration complete message to DU 122-n.

At operation 522, DU 122-n may transmit the RRC reconfiguration complete message to CU 128. DU 122-n may use the signaling radio bearer for transmitting RRC data to UE 110. Note that DU 122-n may generate the RRC data and therefore DU 122-n is able to communicate RRC data with UE 110 independent of CU 128. DU 122-n may also add RRC data to RRC messages received from CU 128.

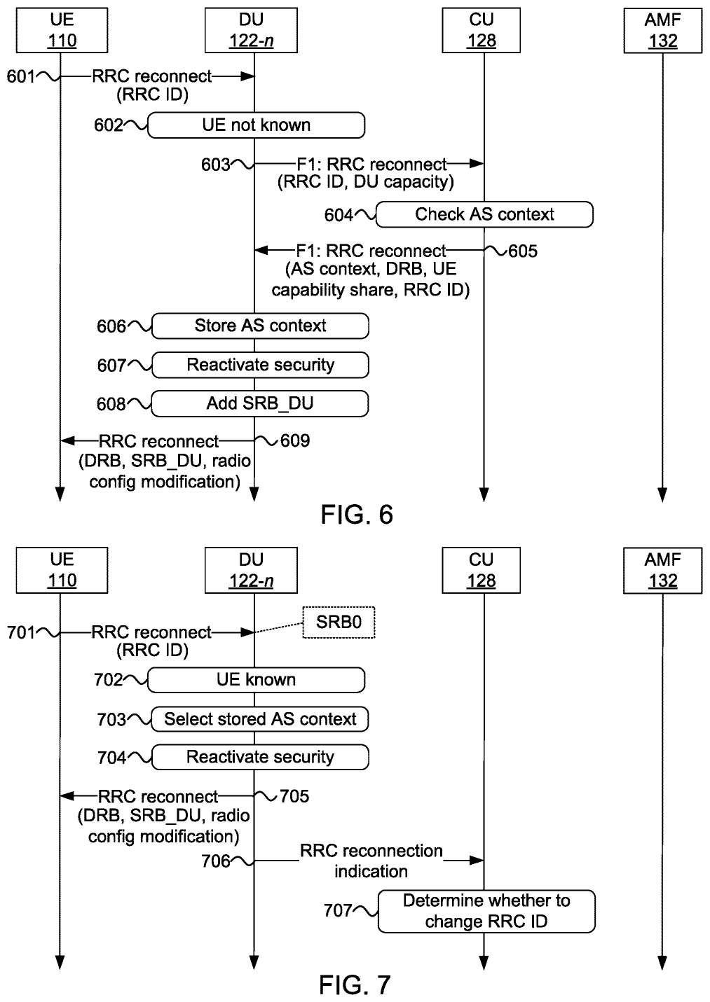

FIG. 6 illustrates an example of a message sequence and operations for RRC reconnection setup when gNB-DU has UE context. In this example, UE 110 may have previously had an RRC connection to the network, for example based on the procedure of FIG. 5, and UE 110 may have stored an RRC ID for resuming the RRC connection. Subsequently, the RRC connection may have been terminated, for example due to a handover or a dropped radio connection. UE 110 may however resume the RRC connection based on the stored RRC_ID, as will be further described below.

At operation 601, UE 110 may transmit an RRC reconnect message (e.g. an RRC reconnect request) to DU 122-n. The RRC reconnect message may include the RRC ID.

At operation 602, DU 122-n may determine whether UE 110 is known. DU 122-n may determine UE 110 to be known if DU 122-n has UE context of UE 110.

At operation 603, in response to determining that UE 110 is not known, DU 122-n may transmit an RRC reconnect message to CU 128, for example over the F1 interface. The RRC reconnect message may include the RRC ID. The RRC reconnect message may include an indication of the capacity available at DU, for example similar to operation 506. The RRC ID may be thus forwarded to CU 128. When UE 110 is known, the system may operate as described with reference to FIG. 7. In general, RRC reconnect/reconfiguration messages may be included in respective F1 messages. For example, the RRC reconnect message of operation 603 may be included in an RRC_MESSAGE_TRANSFER message of the F1 interface. RRC messages may not be directly used at the F1 interface.

At operation 604, CU 128 may check AS context of UE 110. CU 128 may for example determine that AS context of UE 110 is stored at CU 128. When CU 128 is aware of the UE capability available and the estimation about the available capacity of DU 122-n, CU 128 may determine the share of the UE capability that it gives for DU 122-n.

At operation 605, CU 128 may transmit an RRC reconnect message, for example over the F1 interface. The RRC reconnect message may include at least one of the following: the AS context, a configuration of a dedicated radio bearer, the capability share allocated to DU 122-n. This message may be transmitted as response to the RRC reconnect message of operation 603.

At operation 606, DU 122-n may store the AS context, for example similar to operation 516.

At operation, 607, DU 122-n may reactivate security. For example, DU 122-n may reactivate security function(s) for delivery of the RRC data to UE 110. The security function(s) may include for example ciphering of the RRC data. The security function(s) may be based on the AS context of UE 110 received at operation 605.

At operation 608, DU 122-n may add an SRB for DU 122-n (SRB_DU), similar to operation 517.

At operation 609, DU 122-n may transmit an RRC reconnect message to UE 110. The RRC reconnect message may include at least one of the following: the configuration of the dedicated radio bearer, the configuration of the signaling radio bearer, or a radio configuration modification. DU 122-n may then use the signaling radio bearer for transmitting RRC data to UE 110, as described with reference to operation 522. UE 110 may re-establish SRB_DU. However, other previously used signaling radio bearers (e.g. SRB1 and SRB2) may be also active. SRB0 may be configured for RRC messages using a common control channel (CCCH) logical channel. SRB1 may be configured for RRC messages, which may include a piggybacked non-access stratum (NAS) message, as well as for NAS messages prior to the establishment of SRB2, for example using a downlink control channel (DCCH) logical channel. SRB2 may be used for NAS messages and for RRC messages which include logged measurement information, for example using the DCCH logical channel. SRB2 may have a lower priority than SRB1 and may be configured by the network after AS security activation. Operations of FIG. 6 enable fast resumption of RRC connection, when UE 110 is known to DU 122-n. Since RRC ID is not dependent on the serving cell of UE 110, the RRC connection can be resumed in any cell within DU(s) 122 of CU 128.

FIG. 7 illustrates an example of a message sequence and operations for RRC reconnection setup when gNB-DU does not have UE context. The example of FIG. 7 is similar to FIG. 6 in the sense that UE 110 may have previously had an RRC connection to the network. However, in this example UE 110 is know to DU 122-n, which speeds up the RRC reconnection process thanks to the available RRC ID.

At operation 701, UE 110 may transmit an RRC reconnect message to DU 122-n, similar to operation 601.

At operation 702, DU 122-n may determine that UE 110 is known, for example based on availability of corresponding UE context at DU 122-n, as described with reference to operation 602.

At operation 703, DU 122-n may select, based on the RRC ID, a stored AS context of UE 110 for configuring the signaling radio bearer (SRB_DU), in response to determining that UE 110 is known.

At operation 704, DU 122-n may reactivate security, similar to operation 607, but using the stored AS context of UE 110.

At operation 705, DU 122-n may transmit an RRC reconnect message to UE 110. The RRC reconnect message may include at least one of the following: a configuration of the dedicated radio bearer, a configuration of the signaling radio bearer (SRB_DU), and radio configuration modification. The DU 122-n may then use the signaling radio bearer for transmitting RRC data to UE 110, as described with reference to operation 522. Examples of FIG. 7 enable fast resumption of RRC connection, when UE 110 is not known to DU 122-n. Again, since RRC ID is not dependent on the serving cell of UE 110, the RRC connection can be resumed in any cell within the DU(s) 122 of CU 128, even if the relevant DU were not aware of the UE context.

At operation 706, DU 122-n may transmit an indication of RRC reconnection of UE 110 to CU 128. This may indicate to CU 128 that UE 110 has made an RRC reconnection to the network.

At operation 707, CU 128 may determine whether to change the RRC ID. CU 128 may determine validity of the RRC ID, for example in response to receiving the indication of RRC reconnection. CU 128 may for example determine whether the validity period for the RRC ID is still ongoing. In response to detecting expiry of the validity period, CU 128 may update the RRC ID. CU 128 may transmit the updated RRC ID to DU 122-n, which may forward the updated RRC ID to UE 110. The updated RRC ID may be transmitted to DU 122-n similar to the original RRC ID. UE 110 may use the updated RRC ID in subsequent RRC reconnections.

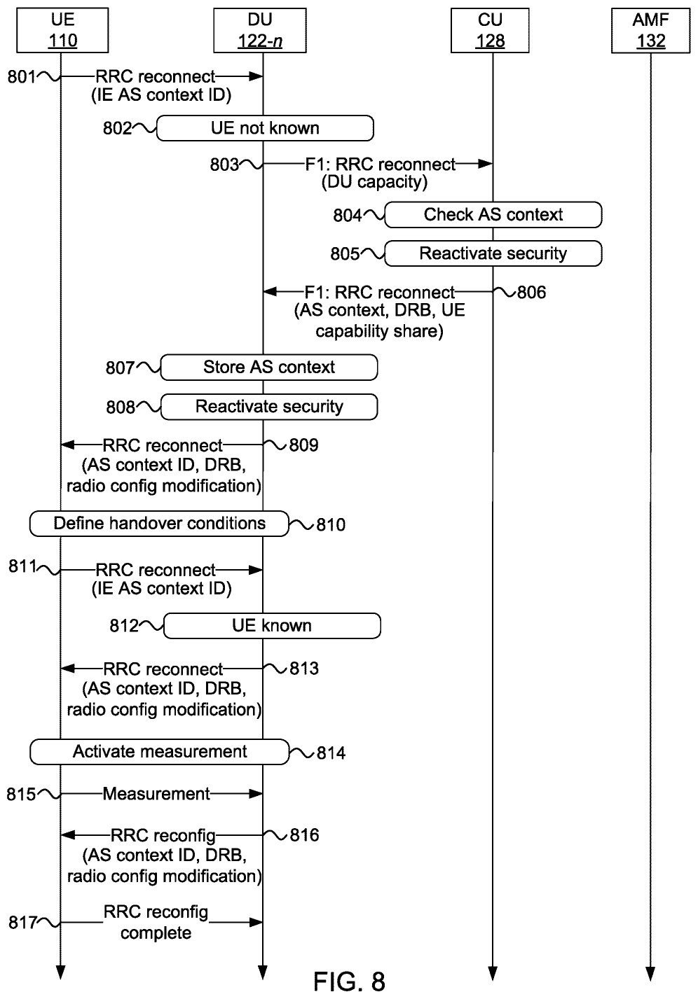

FIG. 8 illustrates an example of a message sequence and operations for different RRC reconnection options. Also in this example UE 110 may have previously had an RRC connection to the network, but UE 110 is known to DU 122-n.

At operation 801, UE 110 may transmit an RRC reconnect message, similar to operation 701. The RRC reconnect message may however include an information element indicative of an AS context ID. AS context ID may be replaced by RRC ID in the example embodiments of FIG. 8.

At operation 802, DU 122-n may determine that UE 110 is not known, similar to operation 802.

At operation 803, DU 122-n may transmit an RRC reconnect message to CU 128, for example over the F1 interface. The RRC reconnect message may include the indication of the available capacity at DU 122-n.

At operation 804, CU 128 may check the AS context, similar to operation 604.

At operation 805, CU 128 may reactivate security, for example as describe for DU 122-n with reference to operation 607.

At operation 806, CU 128 may transmit an RRC reconnect message. The RRC reconnect message may include at least one of the following: AS context, a configuration of a dedicated radio bearer, a capability share allocated to DU 122-n for UE 110.

At operation 807, DU 122-n may store the AS context, similar to operation 606.

At operation 808, DU 122-n may reactivate security, similar to operation 607.

At operation 809, DU 122-n may transmit an RRC reconnect message to UE 110. The RRC reconnect message may include at least one of the following: the AS context ID, the configuration of the dedicated radio bearer, a radio configuration modification. This enables a non-handover-prepared UE to resume the RRC connection both in case of intra-DU and inter-DU mobility or after a drop of radio connection at the same or different DU.

At operation 810, DU 122-n and UE 110 may define handover conditions. In response to detecting the defined conditions, a handover of UE 110 may be performed, for example between cells of DU 122-n.

At operation 811, UE 110 may transmit another RRC reconnect message comprising the AS context ID. This message may be transmitted from a different cell as the corresponding message at operation 801.

At operation 812, DU 122-n may determine that UE 110 known, because it has the AS context of UE 110 (received at operation 806). DU 122-n may therefore directly continue to operation 813, without unnecessary messaging with CU 128. RRC reconnection of UE 110 may be due to intra-DU mobility or drop of radio connection within DU 122-n. This works also for inter-DU mobility or drop when CU 128 has delivered the AS context to DU 122-n. Allocation of transmission resources (e.g. time/frequency resources) may not need to be performed beforehand.

At operation 813, DU 122-n may transmit an RRC reconnect message, similar to operation 809.

At operation 814, DU 122-n and UE 110 may activate measurements. The measurements may include handover measurements. DU 122-n may configure measurements for UE 110 instead of CU 128, for example in case of intra-DU mobility.

At operation 815, DU 122-n may report measurement(s) to DU 122-n.

At operation 816, DU 122-n may transmit an RRC reconfiguration message. The RRC reconfiguration message may include at least one of the following: AS context ID, the configuration the dedicated radio bearer, or radio configuration modification.

At operation 817, UE 110 may transmit an RRC reconfiguration complete message to DU 122-n. This enables UE 110 to resume the RRC connection in case of a network-controlled handover.

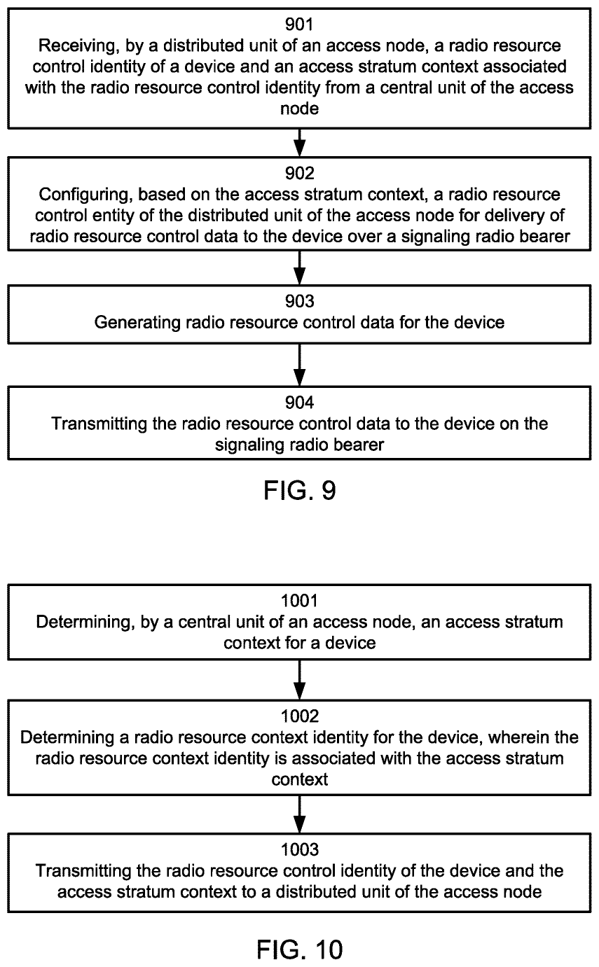

FIG. 9 illustrates an example of a method for radio resource control at a distributed unit of an access node.

At 901, the method may comprise receiving, by a distributed unit of an access node, a radio resource control identity of a device and an access stratum context associated with the radio resource control identity from a central unit of the access node.

At 902, the method may comprise configuring, based on the access stratum context, a radio resource control entity of the distributed unit of the access node for delivery of radio resource control data to the device over a signaling radio bearer.

At 903, the method may comprise generating radio resource control data for the device.

At 904, the method may comprise transmitting the radio resource control data to the device on the signaling radio bearer.

FIG. 10 illustrates an example of a method for radio resource control at a central unit of an access node.

At 1001, the method may comprise determining, by a central unit of an access node, an access stratum context for a device.

At 1002, the method may comprise determining a radio resource context identity for the device, wherein the radio resource context identity is associated with the access stratum context.

At 1003, the method may comprise transmitting the radio resource control identity of the device and the access stratum context to a distributed unit of the access node.

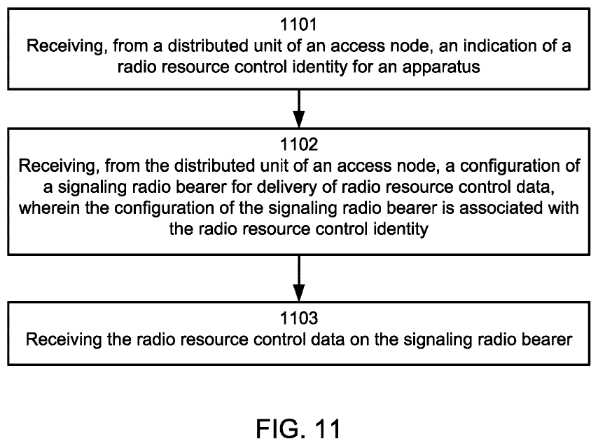

FIG. 11 illustrates an example of a method for radio resource control at a central unit of an access node.

At 1101, the method may comprise receiving, from a distributed unit of an access node, an indication of a radio resource control identity for an apparatus.

At 1102, the method may comprise receiving, from the distributed unit of an access node, a configuration of a signaling radio bearer for delivery of radio resource control data, wherein the configuration of the signaling radio bearer is associated with the radio resource control identity.

At 1103, the method may comprise receiving the radio resource control data on the signaling radio bearer.

Further features of the methods directly result from the functionality of DU(s) 122, CU 128, or UE 110, as described throughout the description, claims, and drawings, and are therefore not repeated here. An apparatus may be configured to perform or cause performance of any aspect of the method(s) described herein. Further, a computer program or a computer program product may comprise instructions for causing, when executed by an apparatus, the apparatus to perform any aspect of the method(s) described herein. Further, an apparatus may comprise means for performing any aspect of the method(s) described herein. According to an example embodiment, the means comprises at least one processor; and at least one memory storing instructions that, when executed by the at least one processor, cause the apparatus at least to perform any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Although subjects may be referred to as ‘first’ or ‘second’ subjects, this does not necessarily indicate any order or importance of the subjects. Instead, such attributes may be used solely for the purpose of making a difference between subjects.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A method, comprising:
receiving, by a distributed unit of an access node, a radio resource control identity of a device and an access stratum context associated with the radio resource control identity from a central unit of the access node;
configuring, based on the access stratum context, a radio resource control entity of the distributed unit of the access node for delivery of radio resource control data to the device over a signaling radio bearer;
generating radio resource control data for the device; and
transmitting the radio resource control data to the device on the signaling radio bearer.

2. The method according to claim 1, wherein the radio resource control identity is independent of a serving cell of the device.

3. The method according to claim 1, further comprising:
transmitting the radio resource control identity to the device.

4. The method according to claim 1, further comprising:
receiving, from the device, an indication of unavailability of the radio resource control identity at the device; and
forwarding the indication of unavailability of the radio resource control identity at the device to the central unit of the access node.

5. The method according to any 1, further comprising:
receiving, from the device, a first radio resource control reconnect message comprising the radio resource control identity; and
forwarding the radio resource control identity to the central unit of the access node, in response to determining that user equipment context of the device is not known to the distributed unit of the access node.

6. The method according to claim 1, further comprising:
receiving, from the device, a first radio resource control reconnect message comprising the radio resource control identity; and
selecting, based on the radio resource control identity, the access stratum context for configuration of the signaling radio bearer, in response to determining that user context of the device is known to the distributed unit of the access node.

7. The method according to claim 5, further comprising:
reactivating, for the delivery of the radio resource control data to the device, at least one security function based on access stratum context.

8. The method according to claim 1, further comprising:
transmitting an indication of available capacity at the distributed unit of the access node to the central unit of the access node; and
receiving an indication of a capability share of the device from the central unit of the access node.

9. A method, comprising:
determining, by a central unit of an access node, an access stratum context for a device;
determining a radio resource context identity for the device, wherein the radio resource context identity is associated with the access stratum context; and
transmitting the radio resource control identity of the device and the access stratum context to a distributed unit of the access node.

10. The method according to claim 9, further comprising:
receiving, from the distributed unit of the access node, an indication of available capacity of the distributed unit of the access node;
allocating a capability share of the device to the distributed unit of the access node; and
transmitting an indication of the capability share of the device to the distributed unit of the access node.

11. The method according to claim 9- or 10, further comprising:
receiving, from the distributed unit of the access node, an indication of radio resource control reconnection of the device;
determining validity of the radio resource control identity of the device;
determining an updated radio resource control identity for the device, in response to determining that the radio resource control identity is not valid; and
transmitting the updated radio resource control identity to the distributed unit of the access node.

12. A method, comprising:
receiving, from a distributed unit of an access node, an indication of a radio resource control identity for an apparatus;
receiving, from the distributed unit of an access node, a configuration of a signaling radio bearer for delivery of radio resource control data, wherein the configuration of the signaling radio bearer is associated with the radio resource control identity; and
receiving the radio resource control data on the signaling radio bearer.

13. The method according to claim 12, further comprising:
transmitting, to the distributed unit of the access node, a radio resource control reconnect message comprising the radio resource control identity.

14. An apparatus comprising at least one processor and at least one memory storing instructions that, when executed by the at least one processor, cause the apparatus to at least perform the method according to claim 1.

15. A non-transitory computer readable medium comprising instructions, which when executed by an apparatus, cause the apparatus perform the method according to claim 1.

16. A non-transitory computer readable medium comprising instructions, which when executed by an apparatus, cause the apparatus perform the method according to claim 9.

17. A non-transitory computer readable medium comprising instructions, which when executed by an apparatus, cause the apparatus perform the method according to claim 12.

18. An apparatus comprising at least one processor and at least one memory storing instructions that, when executed by the at least one processor, cause the apparatus to at least perform the method according to claim 9.

19. An apparatus comprising at least one processor and at least one memory storing instructions that, when executed by the at least one processor, cause the apparatus to at least perform the method according to claim 12.
